(19) United States
(12) Patent Application Publication
(10) Pub. No.: US 2026/0071967 A1
(43) Pub. Date: Mar. 12, 2026

(54) ELECTRIC FIELD ENHANCEMENT DEVICE AND RAMAN SPECTROSCOPIC APPARATUS

(71) Applicant: SEIKO EPSON CORPORATION, Tokyo (JP)

(72) Inventors: Kaho TAKEUCHI, MATSUMOTO-SHI (JP); Fumika YAMADA, SHIOJIRI-SHI (JP); Yoshitaka ITO, MATSUMOTO-SHI (JP)

(73) Assignee: SEIKO EPSON CORPORATION, Tokyo (JP)

(21) Appl. No.: 19/323,927

(22) Filed: Sep. 9, 2025

(30) Foreign Application Priority Data
Sep. 11, 2024 (JP) 2024-157325

(51) Int. Cl. G01N 21/65

(52) U.S. Cl. CPC G01N 21/658

(57) ABSTRACT

An electric field enhancement device includes a substrate, a plurality of microstructures provided to the substrate and having electrical conductivity, a transparent layer configured to cover the plurality of microstructures and the substrate, a first array disposed in a first region of the substrate and including the microstructures periodically arranged, and a second array disposed in a second region different from the first region of the substrate and including the microstructures periodically arranged, wherein the first array and the second array are different from each other in at least one of a diameter of the microstructures, a thickness of the microstructures, and a pitch between the microstructures adjacent to each other.

The present application is based on, and claims priority from JP Application Serial Number 2024-157325, filed Sep. 11, 2024, the disclosure of which is hereby incorporated by reference herein in its entirety.

### BACKGROUND

### 1. Technical Field

The present disclosure relates to an electric field enhancement device and a Raman spectroscopic apparatus.

### 2. Related Art

A Raman spectroscopic apparatus using localized surface plasmon resonance (LSPR) is known as one of spectroscopic techniques for detecting low-concentration sample molecules. In such a Raman spectroscopic apparatus, an enhanced electric field is formed by an electric field enhancement device having a nanometer-scale microstructure to generate surface enhanced Raman scattering (SERS) in which Raman scattered light is enhanced.

For example, JP-A-2013-096939 discloses an optical device including a substrate, a metal microstructure which is configured with a plurality of metal particles and is formed on a surface of the substrate, and an organic molecular film formed on the metal microstructure.

JP-A-2013-096939 is an example of the related art.

In such an optical device as described above, a further improvement in detection sensitivity is required.

In addition, in such an optical device as described above, an arrangement pattern of the metal microstructure, for example, is designed in accordance with the wavelength of incident light. For this reason, there is a problem that the sufficient detection sensitivity is not obtained when the optical sensor is used for incident light having a wavelength different from the design, which degrades the convenience.

### SUMMARY

An electric field enhancement device according to an application example of the present disclosure includes a substrate, a plurality of microstructures provided to the substrate and having electrical conductivity, a transparent layer configured to cover the plurality of microstructures and the substrate, a first array disposed in a first region of the substrate and including the microstructures periodically arranged, and a second array disposed in a second region different from the first region of the substrate and including the microstructures periodically arranged, wherein the first array and the second array are different from each other in at least one of a diameter of the microstructures, a thickness of the microstructures, and a pitch between the microstructures adjacent to each other.

A Raman spectroscopic apparatus according to an application example of the present disclosure includes the above-mentioned electric field enhancement device, a light source configured to irradiate the electric field enhancement device with light, and a detector configured to detect light from the electric field enhancement device.

### BRIEF DESCRIPTION OF THE DRAWINGS

FIG. 1 is a cross-sectional view schematically showing an electric field enhancement device according to an embodiment.

FIG. 2 is a plan view schematically showing the electric field enhancement device according to the embodiment.

FIG. 3 is a diagram showing an example of a planar shape of a microstructure.

FIG. 4 is a conceptual diagram illustrating plasmon resonance in the electric field enhancement device.

FIG. 5 is a conceptual diagram illustrating the plasmon resonance in the electric field enhancement device.

FIG. 6 is a diagram illustrating an enhanced electric field generated by the microstructure of the electric field enhancement device.

FIG. 7 is a plan view schematically showing an electric field enhancement device according to a first modified example of the embodiment.

FIG. 8 is a plan view schematically showing an electric field enhancement device according to a second modified example of the embodiment.

FIG. 9 is a plan view schematically showing an electric field enhancement device according to a third modified example of the embodiment.

FIG. 10 is a graph illustrating an effect provided by the electric field enhancement device shown in FIG. 9.

FIG. 11 is a plan view schematically showing an electric field enhancement device according to a fourth modified example of the embodiment.

FIG. 12 is a graph illustrating an effect provided by the electric field enhancement device shown in FIG. 11.

FIG. 13 is a cross-sectional view schematically showing an electric field enhancement device according to a fifth modified example of the embodiment.

FIG. 14 is a cross-sectional view schematically showing an electric field enhancement device according to a sixth modified example of the embodiment.

FIG. 15 is a diagram schematically showing a Raman spectroscopic apparatus according to the embodiment.

FIG. 16 is a diagram illustrating the principle of Raman scattering spectroscopy.

FIG. 17 is a schematic diagram showing an example of a Raman spectrum acquired by the Raman scattering spectroscopy.

FIG. 18 is an X-Z cross-sectional view schematically showing a repeating unit of a model used in a simulation.

FIG. 19 is an X-Y cross-sectional view schematically showing the model used in the simulation.

FIG. 20 is a table showing a comparison of principal parameters in Practical Examples 1 to 12 and Comparative Example 1.

FIG. 21 is a diagram showing a simulation result of Practical Example 1.

FIG. 22 is a diagram showing a simulation result of Practical Example 2.

FIG. 23 is a diagram showing a simulation result of Practical Example 3.

FIG. 24 is a diagram showing a simulation result of Practical Example 4.

FIG. 25 is a diagram showing a simulation result of Practical Example 5.

FIG. 26 is a diagram showing a simulation result of Practical Example 6.

FIG. 27 is a diagram showing a simulation result of Practical Example 7.

FIG. 28 is a diagram showing the simulation results of Practical Example 8.

FIG. 29 is a diagram showing a simulation result of Practical Example 9.

FIG. 30 is a diagram showing the simulation results of Practical Example 10.

FIG. 31 is a diagram showing the simulation results of Practical Example 11.

FIG. 32 is a diagram showing a simulation result of Practical Example 12.

FIG. 33 is a diagram showing a simulation result of Comparative Example 1.

### DESCRIPTION OF EMBODIMENTS

An electric field enhancement device and a Raman spectroscopic apparatus of the present disclosure will hereinafter be described in detail based on an embodiment shown in the accompanying drawings.

### 1. Electric Field Enhancement Device

First, an electric field enhancement device according to the embodiment will be described.

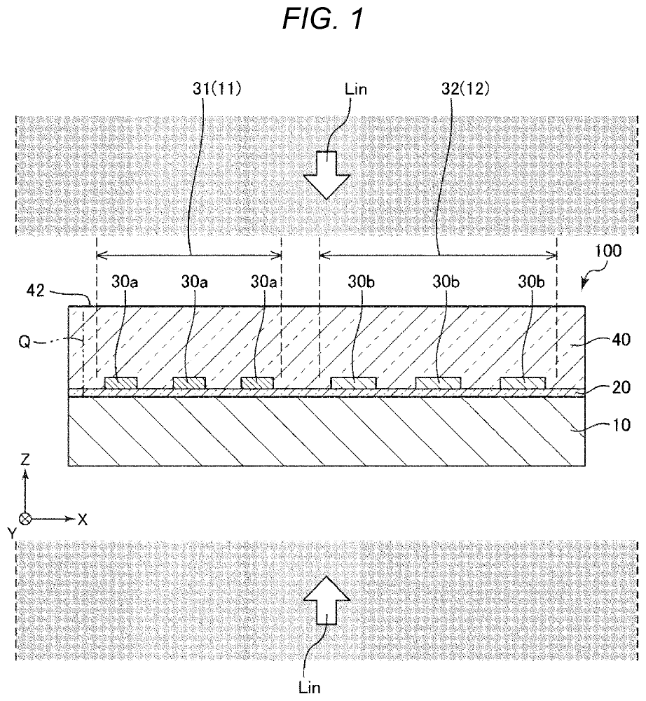

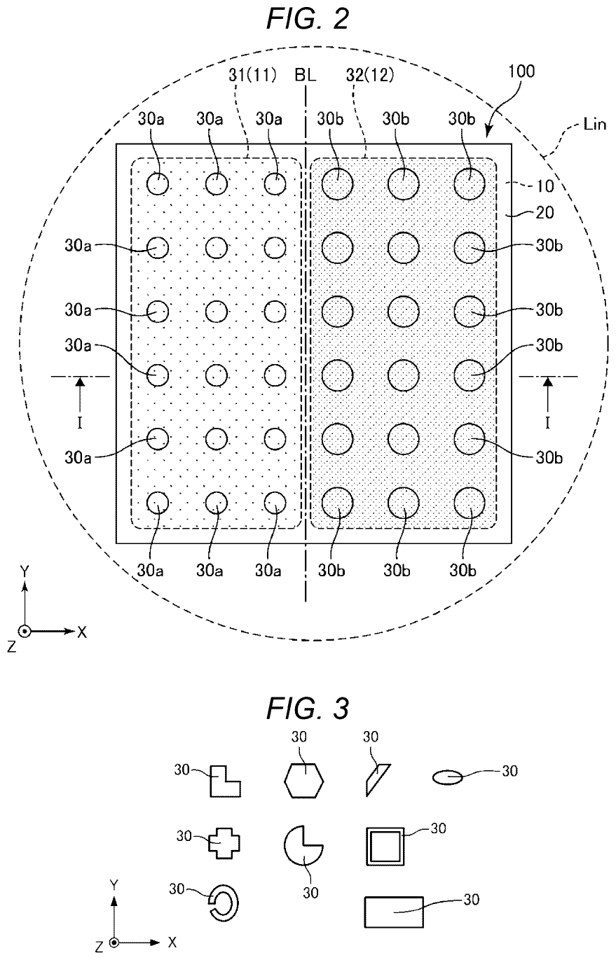

FIG. 1 is a cross-sectional view schematically showing the electric field enhancement device 100 according to the present embodiment. FIG. 2 is a plan view schematically showing the electric field enhancement device 100 according to the embodiment. Note that FIG. 1 is a cross-sectional view along the line I-I in FIG. 2. Further, in each of the drawings of the present application, an X axis, a Y axis, and a Z axis are set as three axes orthogonal to each another, and are respectively indicated by arrows. Further, a tip side of the arrow of each axis is referred to as a “plus side”, and a base end side thereof is referred to as a “minus side”. Further, the Z axis plus side is also referred to as “upside”, and the Z axis minus side is also referred to as “downside”.

### 1.1. Configuration

The electric field enhancement device 100 shown in FIGS. 1 and 2 includes a substrate 10, a dielectric layer 20, microstructures 30a, 30b, and a transparent layer 40. Note that the transparent layer 40 is not shown in FIG. 2.

The substrate 10 supports the plurality of microstructures 30a and the plurality of microstructures 30b via the dielectric layer 20. When light (incident light Lin) from a light source used for Raman scattering is incident from the substrate 10 side in FIG. 1, the incident light Lin is transmitted through the substrate 10 and the dielectric layer 20 and reaches the microstructures 30a, 30b. When the incident light Lin is incident from the transparent layer 40 side in FIG. 1, the incident light Lin is transmitted through the transparent layer 40 and reaches the microstructures 30a, 30b. Note that in this case, when the incident light Lin is incident from the transparent layer 40 side, it may be arranged that the incident light Lin is reflected by the substrate 10 toward the transparent layer 40 side.

When the incident light Lin reaches the plurality of microstructures 30a or the plurality of microstructures 30b, an enhanced electric field is generated. It is sufficient for the enhanced electric field to be formed above the microstructures 30a, 30b, but preferably, the enhanced electric field is maximized at a position at the opposite side of the microstructures 30a, 30b to the substrate 10 in a normal direction to the substrate 10 and separated from the plurality of microstructures 30a, 30b. According to such a configuration, the detection signal caused by the target substance disposed on the transparent layer 40 can be enhanced. Therefore, the electric field enhancement device 100 in which an improvement in the detection sensitivity of the target substance is achieved can be obtained.

Further, in the electric field enhancement device 100 shown in FIG. 2, a first region 11 and a second region 12 are disposed side by side via an imaginary boundary BL along a plane of the substrate 10 when viewed from a normal direction to the substrate 10. The first region 11 and the second region 12 are set in the plane of the substrate 10 and are different from each other. In the case of FIG. 2, an upper surface of the dielectric layer 20 is divided into two via the boundary BL parallel to the Y axis to set the first region 11 and the second region 12 adjacent in the X-axis direction to each other. According to such a configuration, since it is possible to form a plurality of regions with relative ease, it is possible to realize the electric field enhancement device 100 excellent in manufacturing easiness.

Further, a first array 31 in which the microstructures 30a are periodically arranged is disposed in the first region 11. Further, a second array 32 in which the microstructures 30b are periodically arranged is disposed in the second region 12.

In the first array 31 and the second array 32, the microstructures 30a and the microstructures 30b are different from each other in at least one of diameter, thickness, and a pitch between microstructures adjacent to each other. Hereinafter, such diameter, thickness, and pitch are also referred to as array factors. Note that the present embodiment is an example in which the diameter of the microstructure 30a and the diameter of the microstructure 30b are different from each other. Further, two or more of the array factors may be different from each other, or other factors may be different from each other. Examples of other factors include the thickness of the dielectric layer 20 and the thickness of the transparent layer 40. According to such a configuration, it is possible to provide two regions different in array factor together with each other in one electric field enhancement device 100.

When detecting the target substance using the electric field enhancement device 100, the electric field enhancement device 100 is irradiated with the incident light Lin in a state where the target substance is disposed on an upper surface 42 of the transparent layer 40. For example, as illustrated in FIG. 2, an area including the whole of the electric field enhancement device 100 is irradiated with the incident light Lin.

In the first array 31 and the second array 32, since the microstructure 30a and the microstructure 30b are different from each other in diameter (array factor), the wavelength (first excitation wavelength) of the incident light Lin when the first array 31 generates the plasmon resonance and the wavelength (second excitation wavelength) of the incident light Lin when the second array 32 generates the plasmon resonance can be made different from each other. That is, when representing the first excitation wavelength by λ₁ and the second excitation wavelength by λ₂, the electric field enhancement device 100 can generate the enhanced electric field in both cases, that is, when the incident light Lin having the first excitation wavelength λ₁ is used and when the incident light Lin having the second excitation wavelength λ₂ is used. Therefore, it is possible to realize the electric field enhancement device 100 that is capable of coping with a plurality of wavelengths and is therefore high in convenience. As a specific example, it is possible to realize the electric field enhancement device 100 in which the first array 31 corresponds to the incident light Lin having a wavelength of no less than 550 and no more than 660 nm, and the second array 32 corresponds to the incident light Lin having a wavelength of no less than 450 nm and less than 550 nm.

Note that the number of regions (the number of arrays) provided to the electric field enhancement device 100 is not limited to two, and may be three or more. Further, the number of regions and the number of arrays may be different from each other. For example, as described later, when the number of regions is four, the number of arrays may be a smaller number, for example, three.

Further, the area of the first region 11 and the area of the second region 12 may be the same as each other or may be different from each other. In the latter case, it may be arranged that the area ratio is set in accordance with the first excitation wavelength λ₁ and the second excitation wavelength λ₂. For example, since the intensity of the Raman scattered light is inversely proportional to the fourth power of the wavelength of the incident light Lin, the shorter the wavelength of the incident light Lin, the higher the intensity of the Raman scattered light. In the light of the above, for example, when the second excitation wavelength λ₂ is shorter than the first excitation wavelength λ₁, it is preferable for the area of the first region 11 to be made larger than the area of the second region 12. Accordingly, the intensity of the Raman scattered light generated by the incident light Lin having the first excitation wavelength Mi and the intensity of the Raman scattered light generated by the incident light Lin having the second excitation wavelength λ₂ can be made approximate to each other. As a result, it is possible to realize the electric field enhancement device 100 in which the difference in the intensity of the Raman scattered light between the regions is small, and which is easy to use.

Examples of the substrate 10 include a glass substrate and a silicon substrate. Examples of the material of the glass substrate include SiO₂ (quartz glass). Examples of the material of the silicon substrate include single crystal silicon, polycrystalline silicon, and amorphous silicon.

In FIG. 1, a normal line to the upper surface of the substrate 10 is represented by Q. In FIG. 1, a normal line Q is set to be parallel to the Z axis.

The dielectric layer 20 shown in FIG. 1 is disposed between the substrate 10 and the microstructures 30a, 30b. The thickness of the dielectric layer 20 is not particularly limited, but is preferably no less than 1 nm and no more than 2000 nm, and more preferably no less than 10 nm and no more than 1000 nm. Note that the dielectric layer 20 may be omitted.

The thickness of the dielectric layer 20 is measured from an observation image obtained by observing a cross-section of the dielectric layer 20 with an electron microscope. In the observation image, the length in the Z-axis direction of the dielectric layer 20 is measured at 10 or more points extracted randomly, and an average value thereof is defined as the “thickness”.

The dielectric layer 20 is transparent with respect to the incident light Lin. Examples of the material of the dielectric layer 20 include Al₂O₃, TiO₂, MgO, LiNbO₃, HfO₂, Ta₂O₅, SiON, Si₃N₄, SiOx (0<x<3), PMMA (acrylic resin), PVA (polyvinyl alcohol), polysilazane, and polystyrene. The dielectric layer 20 may be formed of a plurality of layers. In this case, the materials of the plurality of layers may be the same as each other, or may be different from each other.

The microstructures 30a, 30b illustrated in FIG. 1 are disposed between the dielectric layer 20 and the transparent layer 40. The microstructures 30a, 30b each have, for example, a cylindrical shape. The diameter of the microstructure 30a and the diameter of the microstructure 30b are not particularly limited, but are each preferably no less than 1 nm and no more than 1000 nm, more preferably no less than 5 nm and no more than 500 nm, and still more preferably no less than 10 nm and no more than 400 nm.

Note that when the planar shape of the microstructure 30a (the shape when viewed along the normal line Q) is a circle, the “diameter of the microstructure 30a” is a diameter of the circle, and when the planar shape of the microstructure 30a is not a circle, the “diameter of the microstructure 30a” is a diameter of a minimum inclusion circle. As an example of the latter, when the planar shape of the microstructure 30a is a polygon, a minimum circle including the polygon inside is the “minimum inclusion circle”. Further, when the planar shape of the microstructure 30a is an ellipse, a minimum circle including the ellipse inside is the “minimum inclusion circle”. The same applies to the diameter of the microstructure 30b.

The thicknesses of the microstructures 30a, 30b are not particularly limited, but are each preferably no less than 1 nm and no more than 500 nm, more preferably no less than 5 nm and no more than 300 nm, and still more preferably no less than 30 nm and no more than 200 nm. Accordingly, the enhanced electric field can further be strengthened.

A plurality of microstructures 30a and a plurality of microstructures 30b are provided. The plurality of microstructures 30a and the plurality of microstructures 30b are separated from each other. The transparent layer 40 is disposed between the microstructures 30a adjacent to each other, and is disposed between the microstructures 30b adjacent to each other. The pitch of the microstructures 30a adjacent to each other and the pitch of the microstructures 30b adjacent to each other are not particularly limited, but are each preferably no less than 20 nm and no more than 1000 nm, and more preferably no less than 100 nm and no more than 900 nm.

The plurality of microstructures 30a and the plurality of microstructures 30b are each periodically disposed. In the example illustrated in FIG. 2, the plurality of microstructures 30a and the plurality of microstructures 30b are each arranged in a square lattice shape.

According to such a configuration, in the electric field enhancement device 100, it is possible to reduce a variation in the intensity of the enhanced electric field in an in-plane direction. When a plurality of microstructures is randomly arranged, only the microstructures having a pitch and a diameter matching the wavelength of the incident light Lin induce the LSPR. Therefore, there is a possibility that the intensity of the enhanced electric field varies in the in-plane direction. In contrast, since the microstructures 30 are periodically disposed, it is possible to induce surface lattice resonance (SLR) described later.

Note that the “pitch of the microstructures 30a, 30b” is a distance between the centers of the microstructures 30a, 30b adjacent to each other in a predetermined direction. When the planar shape of the microstructure 30a is a circle, the “center of the microstructure 30a” is the center of the circle, and when the planar shape of the microstructure 30a is not a circle, the “center of the microstructure 30a” is the center of the minimum inclusion circle. The same applies to the “center of the microstructure 30b”.

In addition, at least one of the plurality of microstructures 30a and the plurality of microstructures 30b may be disposed in a triangular lattice shape when viewed from the normal line Q. Further, although not illustrated, the periodicity of the plurality of microstructures 30a, 30b may expand or contract at a certain ratio, and the plurality of microstructures 30a, 30b may include a fractal structure.

FIG. 3 is a diagram illustrating examples of the planar shape of the microstructures 30a, 30b.

The planar shape of the microstructures 30a, 30b is not limited to the circular shape described above, and may be an elliptical shape, a rectangular shape, a particle shape, a polygonal shape, an annular shape, a linear shape, or the like as the microstructures 30 illustrated in FIG. 3.

Further, the plurality of microstructures 30a, 30b may each be a combination of those different in shape. Accordingly, it is possible to control the intensity and distribution of the enhanced electric field generated by the plurality of microstructures 30a, 30b in the in-plane direction orthogonal to the normal line Q.

In addition, the cross-sectional shape of the microstructures 30a, 30b is not particularly limited, and may be a trapezoid, a semicircle, a circle, a reverse tapered shape, a tip spherical shape, or the like. Further, the shapes of the microstructures 30a, 30b may each be a truncated quadrangular pyramid or a cone.

Further, although not illustrated, a plurality of recesses may be provided to the upper surface of the dielectric layer 20, and the microstructures 30a, 30b may be disposed in the recesses.

The microstructures 30a, 30b have electrical conductivity. Examples of the material of the microstructures 30a, 30b include simple substances or alloys of metals such as Al, Au, Ag, Cu, Pt, Pd, and Ni. Since such a metal has particularly good electrical conductivity, the enhanced electric field can be further strengthened. Further, the microstructures 30a, 30b may be metal particles. Note that the material of the microstructures 30a, 30b is not particularly limited as long as the material has a plasma frequency with respect to the incident light Lin, and may be a transparent electrode material such as indium tin oxide (ITO), a carbon-based material such as carbon nanotubes, or the like.

The transparent layer 40 is disposed on the microstructures 30a, 30b and the dielectric layer 20. That is, the transparent layer 40 is disposed to cover the plurality of microstructures 30a, the plurality of microstructures 30b, and the substrate 10. The thickness of the transparent layer 40 is not particularly limited, but is preferably no less than 10 nm and no more than 2000 nm, and more preferably no less than 20 nm and no more than 1000 nm.

The thickness of the transparent layer 40 is measured from an observation image obtained by observing a cross-sectional surface of the transparent layer 40 with an electron microscope. In the observation image, the length in the Z-axis direction of the transparent layer 40 is measured at 10 or more points randomly extracted, and an average value thereof is defined as the “thickness”.

The transparent layer 40 is transparent with respect to the incident light Lin. Examples of the material of the transparent layer 40 include various dielectric materials such as Al₂O₃, TiO₂, MgO, LiNbO₃, HfO₂, Ta₂O₅, SiON, Si₃N₄, and SiOx (0<x<3). Further, SiOx (0<x<3) is preferably SiOx (1<x≤2). Note that the material of the transparent layer 40 may be an organic material such as PMMA (acrylic resin), PVA (polyvinyl alcohol), polysilazane, or polystyrene.

The refractive index of the transparent layer 40 may be different from, or may be the same as, the refractive index of the dielectric layer 20. When the refractive index of the transparent layer 40 is the same as the refractive index of the dielectric layer 20, a Rayleigh anomaly described later is apt to be generated. Further, when the dielectric layer 20 is omitted, the refractive index of the transparent layer 40 may be higher, or may be lower, than the refractive index of the substrate 10, but the difference therebetween is preferably set to no more than 0.20. When the refractive index difference is within this range, the influence of the refractive index difference is suppressed, and the Rayleigh anomaly described later is likely to occur regardless of the incident direction of the light. As a result, the SLR described later is apt to be induced. Note that when the refractive index difference is out of the range described above, when, for example, the light is incident from the substrate 10 side, Fresnel reflection is likely to occur on an interface between the substrate 10 and the transparent layer 40. As a result, there is a possibility that the optical energy making a contribution to the generation of the plasmon resonance described later decreases to decrease the enhanced electric field.

The transparent layer 40 has the upper surface 42. The upper surface 42 is, for example, an interface between the transparent layer 40 and an air layer. Further, the upper surface 42 is a surface on which the target substance to be detected is disposed. The upper surface 42 shown in FIG. 1 is preferably a flat surface. In this case, the target substance can be stably arranged.

### 1.2. Enhanced Electric Field

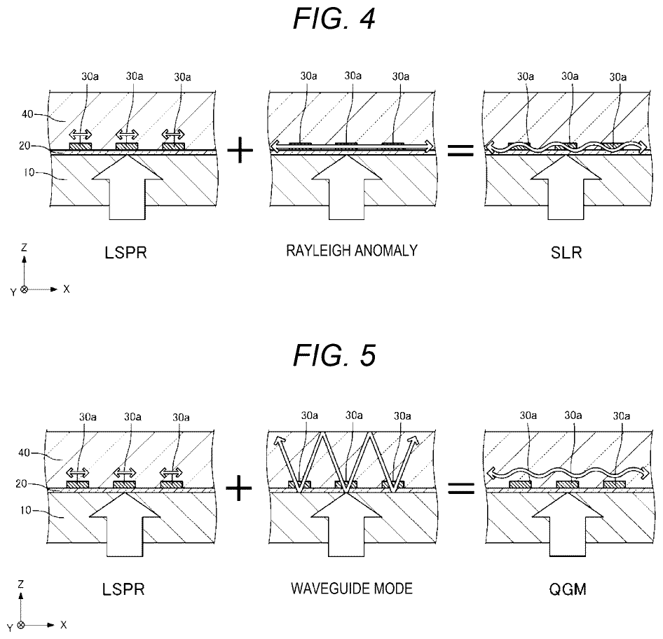

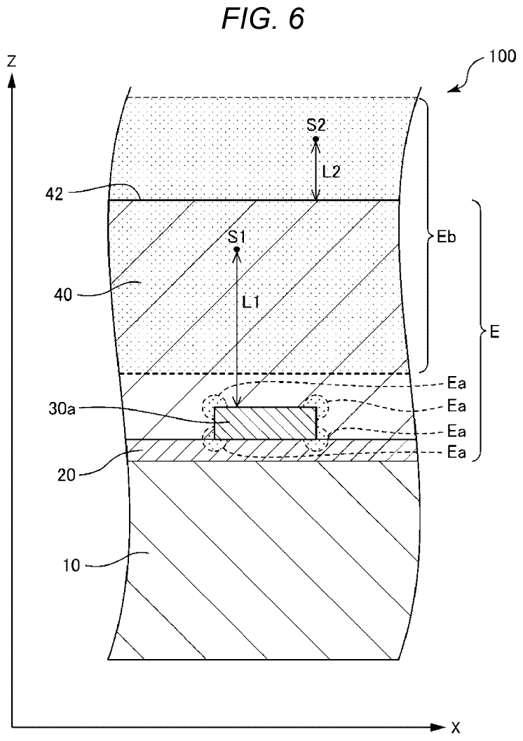

FIGS. 4 and 5 are conceptual diagrams illustrating the plasmon resonance in the electric field enhancement device 100. FIG. 6 is a diagram illustrating an enhanced electric field generated by the microstructure 30a of the electric field enhancement device 100. Note that since the enhanced electric field generated by the microstructure 30b is substantially the same as the enhanced electric field generated by the microstructure 30a, the description thereof will be omitted.

In the example illustrated in FIGS. 4 and 5, the light incident from the substrate 10 side reaches the plurality of microstructures 30a. The light that has reached the microstructure 30a causes the plurality of microstructures 30a to generate the plasmon resonance. The wavelength of the light is, for example, no less than 350 nm and no more than 850 nm. When the wavelength of light is within the range described above, the plasmon resonance is easily generated in the microstructure 30a.

As shown in FIG. 4, when the light reaches the microstructure 30a, the LSPR described above is induced. In addition, 90°-diffraction by the plurality of microstructures 30a, that is, Rayleigh anomaly occurs. When the Rayleigh anomaly and the LSPR are combined, the surface lattice resonance (SLR) is induced.

Further, as shown in FIG. 5, the incident light is guided through the transparent layer 40. By combining the waveguide mode in the transparent layer 40 and the LSPR, a quasi-guided mode (QGM) is induced.

Then, the SLR and the resonance state such as QGM are combined and cooperate, and cooperative plasmon polaritons are induced in the plurality of microstructures 30a. As illustrated in FIG. 6, the enhanced electric field E generated by the plurality of microstructures 30a due to the combination of the SLR and the resonance state such as the QGM includes not only first enhanced fields Ea generated at ends of the microstructures 30a due to the LSPR but also a second enhanced field Eb generated above the microstructures 30a due to the SLR and the resonance state such as the QGM.

The enhanced electric field E enhances the Raman scattered light and generates the SERS. The enhanced electric field E is maximized by the second enhanced field Eb at a position S1 or a position S2 (the position S1 or the position S2 located at an opposite side of the plurality of microstructures 30a to the substrate 10 in the normal direction and separated from the plurality of microstructures 30a) separated upward from the plurality of microstructures 30a. It can be said to be a feature of the phenomenon of the cooperative plasmon polariton that the enhanced electric field E is maximized at the position S1 or the position S2. The position S1 and the position S2 shown in FIG. 6 are located at the Z axis plus side of the plurality of microstructures 30a.

According to such a configuration, the detection sensitivity of the electric field enhancement device 100 can be improved. For example, when the enhanced electric field E is generated only at the end of the microstructure 30a due to the LSPR, the effect that the enhanced electric field E is generated cannot be obtained unless the target substance is located in the vicinity of the microstructure 30a. In general, since the probability that the target substance is located in the vicinity of the microstructure varies, the detection sensitivity is likely to decrease when the enhanced electric field is generated only at the end of the microstructure. In addition, the reproducibility of the detection also decreases. Further, when the size of the target substance is large, the target substance cannot enter an area between the microstructures adjacent to each other, and it may be difficult to locate the target substance near the microstructure in some cases.

In contrast, in the electric field enhancement device 100, the enhanced electric field E generated by the plurality of microstructures 30a is maximized at the position S1 or the position S2 (the position S1 or the position S2 separated from the plurality of microstructures 30a located at the opposite side of the plurality of microstructures 30a to the substrate 10 in the normal direction) separated upward from the plurality of microstructures 30a in the normal direction. Therefore, the detection signal caused by the target substance can be enhanced without locating the target substance in the vicinity of the microstructure 30a. As a result, the detection sensitivity can be improved. In addition, since it is not necessary to locate the target substance between the microstructures 30a adjacent to each other, samples in various sizes such as viruses and bacteria can be freely selected as the target substances.

Further, in the electric field enhancement device 100, since the position S1 or the position S2 of the local maximum point is separated from the vicinity of the microstructure 30a, it is possible to provide the transparent layer 40 that covers the microstructure 30a. That is, even when the transparent layer 40 is provided, it is possible to apply the enhanced electric field E to the target substance to enhance the detection signal caused by the target substance. Therefore, unintended chemical changes such as oxidation and sulfurization of the microstructure 30a can be suppressed. In particular, Ag is likely to be altered or deformed by oxidation, sulfurization, migration, or the like. In the electric field enhancement device 100, even when Ag is used as the microstructure 30a, such alteration and deformation can be suppressed. As a result, the durability and reliability of the electric field enhancement device 100 can be improved.

Further, in the electric field enhancement device 100, unevenness due to the plurality of microstructures 30a can be alleviated by the transparent layer 40. Therefore, flatness of the surface to be in contact with the target substance can be improved. Thus, the variation of the detection signal due to the target substance can be reduced in the in-plane direction.

Note that the second enhanced field Eb may be separated from the first enhanced field Ea as illustrated in FIG. 6, or may be continuous with the first enhanced field Ea.

Further, in FIG. 6, the local maximum point at which the enhanced electric field E is maximized is located at the position S1 or the position S2. Out of these, the position S1 shown in FIG. 6 is located in the transparent layer 40. In this case, in a normal direction to the upper surface 42, a distance L1 from the microstructure 30a to the position S1 may be less than 100 nm, but is preferably no less than 100 nm, and more preferably no less than 200 nm. Accordingly, since the enhanced electric field E generated above the upper surface 42 can also be strengthened, even when the target substance is not located in the vicinity of the microstructure 30a, in other words, even when the target substance is disposed on the upper surface 42, the enhanced electric field E acts on the target substance, and the detection signal caused by the target substance can be enhanced.

Further, in FIG. 6, the enhanced electric field E reaches the air layer across the upper surface 42. Further, the local maximum point of the enhanced electric field E may be located at the position S2 shown in FIG. 6. The position S2 shown in FIG. 6 is located in the air layer. That is, the enhanced electric field E may be maximized at a position separated from the transparent layer 40 in the normal direction to the upper surface 42. In this case, the detection signal caused by the target substance disposed on the upper surface 42 can be further enhanced.

Further, in this case, a distance L2 from the upper surface 42 (a surface of the transparent layer 40) to the position S2 (the local maximum point) may be no more than 100 nm, or may be more than 100 nm.

When the distance L2 is no more than 100 nm, the probability that the position S2 acts on the target substance disposed on the upper surface 42 is high as long as the size of the target substance is no more than 100 nm. Therefore, the detection signal caused by the target substance can be particularly enhanced.

When the distance L2 exceeds 100 nm, even when the size of the target substance exceeds 100 nm, the probability that the position S2 acts on the target substance disposed on the upper surface 42 is high. Therefore, even when target substances in various sizes are mixed, the detection signals caused by the target substances can be uniformly enhanced.

### 2. Method of Manufacturing Electric Field Enhancement Device

Then, an example of a method of manufacturing the electric field enhancement device 100 will be described.

First, the dielectric layer 20 is formed on the substrate 10. The dielectric layer 20 is formed by, for example, a vapor deposition method, a sputtering method, a chemical vapor deposition (CVD) method, or an atomic layer deposition (ALD) method.

Then, the plurality of microstructures 30a, 30b is formed on the dielectric layer 20. The microstructures 30a, 30b are formed by forming a thin film using, for example, a vacuum deposition method or a sputtering method, and then patterning the thin film. Examples of the patterning method include electron beam (EB) lithography, photolithography and etching, a microcontact printing method, and a nanoimprint method.

Then, the transparent layer 40 is formed on the dielectric layer 20 and the microstructures 30a, 30b. Accordingly, the electric field enhancement device 100 can be obtained. The transparent layer 40 is formed by, for example, a vapor deposition method, a sputtering method, a CVD method, an ALD method, or a sol-gel method.

### 3. Modified Example of Electric Field Enhancement Device

Then, an electric field enhancement device according to a modified example of the embodiment will be described.

### 3.1. First Modified Example

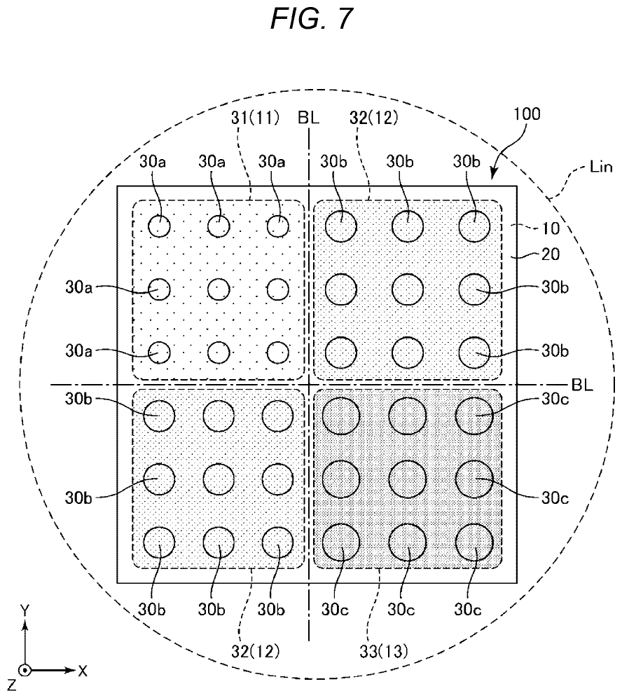

FIG. 7 is a plan view schematically illustrating an electric field enhancement device 100 according to a first modified example of the embodiment.

The first modified example will hereinafter be described, but in the following description, differences from the embodiment described above will mainly be described, and description of similar matters will be omitted. Note that in FIG. 7, substantially the same configurations as those in the embodiment described above are provided with the same reference symbols.

The first modified example is substantially the same as the embodiment described above except that three types of regions are arranged in a matrix.

In the electric field enhancement device 100 shown in FIG. 7, the first region 11, the second regions 12, and a third region 13 are arranged via boundarys BL along the plane of the substrate 10 when viewed from the normal direction of the substrate 10. In the case of FIG. 7, the upper surface of the dielectric layer 20 is divided into four regions via the boundary BL parallel to the X axis and the boundary BL parallel to the Y axis to set the first region 11, the two second regions 12, and the third region 13 arranged in a 2×2 matrix.

Further, the first array 31 in which the microstructures 30a are periodically arranged is disposed in the first region 11. Further, the second array 32 in which the microstructures 30b are periodically arranged is disposed in the second region 12. Further, a third array 33 in which microstructures 30c are periodically arranged is disposed in the third region 13.

In the first array 31, the second array 32, and the third array 33, the microstructures 30a, the microstructure 30b, and the microstructure 30c are different from each other in at least one of diameter, thickness, and a pitch between microstructures adjacent to each other. Note that the present modified example is an example in which the diameter of the microstructure 30a, the diameter of the microstructure 30b, and the diameter of the microstructure 30c are different from each other.

According to such a configuration, the wavelength (the first excitation wavelength λ₁) of the incident light Lin when the first array 31 generates the plasmon resonance, the wavelength (the second excitation wavelength λ₂) of the incident light Lin when the second array 32 generates the plasmon resonance, and the wavelength (a third excitation wavelength λ₃) of the incident light Lin when the third array 33 generates the plasmon resonance can be made different from each other. That is, it is possible to realize the electric field enhancement device 100 capable of generating the enhanced electric field in all the cases, that is, when the incident light Lin having the wavelength corresponding to the first excitation wavelength λ₁ is used, when the incident light Lin having the wavelength corresponding to the second excitation wavelength λ₂ is used, and when the incident light Lin having the wavelength corresponding to the third excitation wavelength λ₃ is used.

Further, in the present modified example, the area of the second regions 12 is set to be larger than the area of the first region 11 and the area of the third region 13. In this case, the intensity of the Raman scattered light generated by the incident light Lin having the second excitation wavelength λ₂ can selectively be made higher. Accordingly, it is possible to realize the electric field enhancement device 100 capable of coping with the incident light Lin having the first excitation wavelength λ₁ and the incident light Lin having the third excitation wavelength λ₃ while ensuring in particular the high intensity of the Raman scattered light with respect to the incident light Lin having the second excitation wavelength λ₂.

Note that the arrangement patterns of the respective regions illustrated in FIG. 7 are an example, and are not limited thereto. For example, in FIG. 7, two second regions 12, 12 are disposed at diagonal positions, but may be disposed at positions aligned along the X axis or the Y axis. Further, the position of the first region 11 and the position of the third region 13 may be exchanged with each other.

Note that in such a first modified example as described above, substantially the same advantages as those of the embodiment described above can be obtained.

### 3.2. Second Modified Example

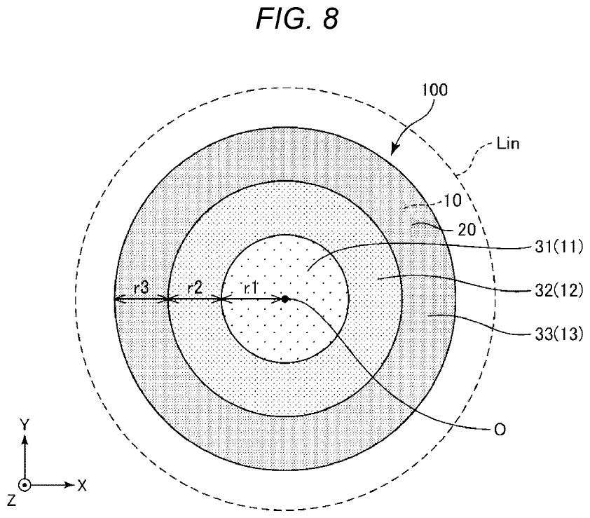

FIG. 8 is a plan view schematically illustrating an electric field enhancement device 100 according to a second modified example of the embodiment.

The second modified example will hereinafter be described, but in the following description, differences from the embodiment described above will mainly be described, and description of similar matters will be omitted. Note that in FIG. 8, substantially the same configurations as those in the embodiment described above are provided with the same reference symbols.

The second modified example is substantially the same as the embodiment described above except that three types of regions are concentrically arranged.

In the electric field enhancement device 100 shown in FIG. 8, the substrate 10 has a circular shape when viewed from the normal direction to the substrate 10. Further, the first region 11, the second region 12, and the third region 13 are arranged concentrically around the center O of the substrate 10. In the case of FIG. 8, the first region 11 is set to include the center O, the second region 12 is set adjacent to an outside of the first region 11, and the third region 13 is set adjacent to an outside of the second region 12.

Further, the first array 31 described above is disposed in the first region 11. Further, the second array 32 described above is disposed in the second region 12. Further, the third array 33 described above is disposed in the third region 13. Note that in FIG. 8, the microstructures are not shown.

Further, the width of the first region 11 in the radial direction of the substrate 10 is represented by r1, the width of the second region 12 is represented by r2, and the width of the third region 13 is represented by r3. In FIG. 8, the width r1, the width r2, and the width r3 are set to be equal to each other. In this case, the first region 11 has the smallest area, the second region 12 is larger in area than the first region 11, and the third region 13 has the largest area. When the in-plane distribution of the light intensity of the incident light Lin is supposedly constant, the intensity of the Raman scattered light generated by the incident light Lin having the second excitation wavelength λ₂ or the third excitation wavelength λ₃ can be made higher than the intensity of the Raman scattered light generated by the incident light Lin having the first excitation wavelength λ₁. Accordingly, it is possible to realize the electric field enhancement device 100 capable of coping with the incident light Lin having the first excitation wavelength λ₁ while ensuring in particular the high intensity of the Raman scattered light with respect to the incident light Lin having the second excitation wavelength λ₂ or the third excitation wavelength λ₃. Therefore, it is possible to realize the electric field enhancement device 100 in which the difference in the intensity of the Raman scattered light between the regions is small, and which is easy to use.

On the other hand, the in-plane distribution of the light intensity of the incident light Lin is not constant in many cases. This case will be described later in detail.

In addition, by adjusting the widths r1, r2, and r3 in accordance with the in-plane distribution of the light intensity of the incident light Lin, the ratio of the intensity of the Raman scattered light between the regions can easily be adjusted. Accordingly, it is possible to realize the electric field enhancement device 100 capable of coping with the plurality of wavelengths of the incident light Lin and optimizing the ratio of the intensity of the Raman scattered light between the regions.

Note that in such a second modified example as described above, substantially the same advantages as those of the embodiment described above can be obtained.

Further, the shape of the substrate 10 is not limited to the circle, and may be, for example, an ellipse, an oval, a polygon, or other shapes.

Further, each of outer edges of the first region 11, the second d region 12, and the third region 13 concentrically arranged may be an ellipse, an oval, a polygon, or the like besides a perfect circle. Further, the outer edges may be different in shape from each other. In the present specification, the concentric shape includes such cases.

### 3.3. Third Modified Example

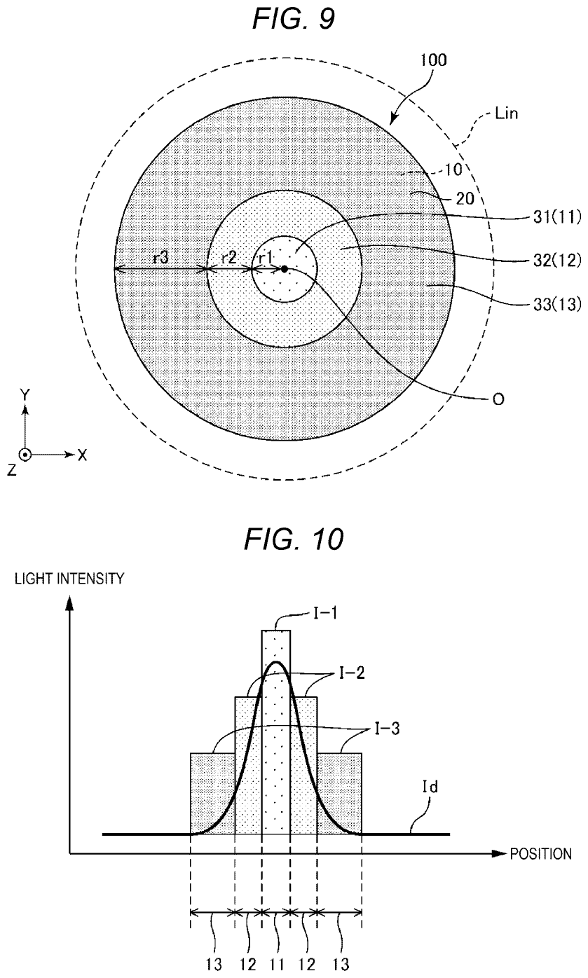

FIG. 9 is a plan view schematically illustrating an electric field enhancement device 100 according to a third modified example of the embodiment.

The third modified example will hereinafter be described focusing attention on differences from the second modified example, and the description of substantially the same matters will be omitted. Note that in FIG. 9, substantially the same configurations as those in the embodiment described above are provided with the same reference symbols.

The third modified example is substantially the same as the second modified example except that the widths of the three types of regions are optimized in accordance with the light intensity distribution of the incident light Lin.

In the electric field enhancement device 100 shown in FIG. 9, the width r1 is set to be narrower than the width r2, and the width r3 is set to be wider than the width r2. In this case, the area of the first region 11 is smaller than that in the second modified example, and the area of the third region 13 is larger than that in the second modified example. By optimizing the widths r1, r2, and r3 in this way, an integrated value of the light intensity of the incident light Lin in the first region 11, an integrated value of the light intensity of the incident light Lin in the second region 12, and an integrated value of the light intensity of the incident light Lin in the third region 13 can be freely adjusted, and thus, it is possible to, for example, uniform the integrated values of the light intensity of the incident light Lin in the respective regions with each other or reduce the difference therebetween.

FIG. 10 is a graph illustrating the effect of the electric field enhancement device 100 shown in FIG. 9.

A light intensity distribution Id illustrated in FIG. 10 represents a light intensity distribution in a cross-section of the incident light Lin. As illustrated in FIG. 10, the distribution of the light intensity in the cross-section of the incident light Lin used in the Raman scattering spectroscopy is generally a Gaussian distribution. Therefore, the integrated value of the light intensity, that is, the integrated light amount is larger in a central portion of the incident light Lin than in end portions. In FIG. 10, the integral value I-1 of the light intensity in the first region 11, the integral value I-2 of the light intensity in the second region 12, and the integral value I-3 of the light intensity in the third region 13 are represented by the areas of quadrangles. The integral value I-1 of the light intensity in the first region 11, the integral value I-2 of the light intensity in the second region 12, and the integral value I-3 of the light intensity in the third region 13 are equal to each other. Specifically, although the relative area of the first region 11 is the smallest, the relative intensity of the light applied to the first region 11 is the highest. Meanwhile, the relative area of the third region 13 is the largest, but the relative intensity of the light applied to the third region 13 is the lowest. Further, the relative area of the second region 12 is medium, and the relative intensity of the light applied to the second region 12 is also medium.

According to the configuration described above, it is possible to realize the electric field enhancement device 100 capable of generating the enhanced electric fields equivalent to each other in the respective cases, that is, when the incident light Lin having the wavelength corresponding to the first excitation wavelength λ₁ is used, when the incident light Lin having the wavelength corresponding to the second excitation wavelength λ₂ is used, and when the incident light Lin having the wavelength corresponding to the third excitation wavelength λ₃ is used. Therefore, it is possible to realize the electric field enhancement device 100 in which the difference in the intensity of the Raman scattered light between the regions is small, and which is easy to use.

Note that in such a third modified example as described above, substantially the same advantages as those of the embodiment described above can be obtained.

### 3.4. Fourth Modified Example

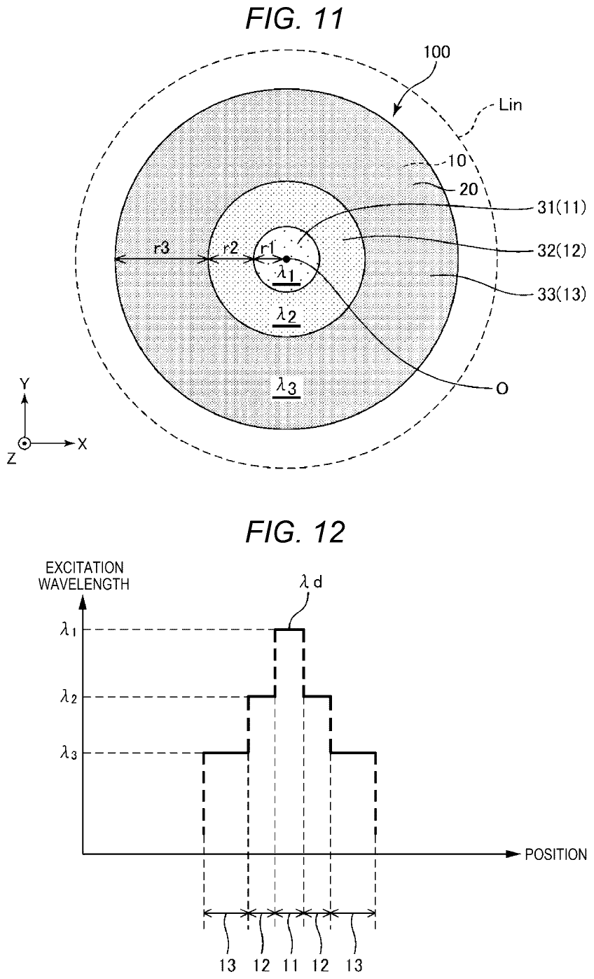

FIG. 11 is a plan view schematically illustrating an electric field enhancement device 100 according to a fourth modified example of the embodiment.

The fourth modified example will hereinafter be described focusing attention on differences from the second modified example, and the description of substantially the same matters will be omitted. Note that in FIG. 11, substantially the same configurations as those in the embodiment described above are provided with the same reference symbols.

The fourth modified example is substantially the same as the second modified example except that the arrangement of the three types of regions is optimized in accordance with the wavelength of the incident light Lin.

In the electric field enhancement device 100 shown in FIG. 11, similarly to FIG. 9, the first region 11 is set to include the center O, the second region 12 is set adjacent to an outside of the first region 11, and the third region 13 is set adjacent to an outside of the second region 12. In addition, the first array 31 that generates the plasmon resonance at the first excitation wavelength λ₁ is disposed in the first region 11, the second array 32 that generates the plasmon resonance at the second excitation wavelength λ₂ is disposed in the second region 12, and the third array 33 that generates the plasmon resonance at the third excitation wavelength λ₃ is disposed in the third region 13. Further, the first excitation wavelength λ₁, the second excitation wavelength λ₂, and the third excitation wavelength λ₃ satisfy a relationship of λ₃<λ₂<λ₁. As a result, the intensities of the Raman scattered light in the respective regions can be made equal to each other, or a difference therebetween can be reduced.

FIG. 12 is a graph illustrating the effect of the electric field enhancement device 100 shown in FIG. 11.

The excitation wavelength distribution λd illustrated in FIG. 12 represents a distribution of the first excitation wavelength λ₁ set in the first region 11, the second excitation wavelength λ₂ set in the second region 12, and the third excitation wavelength λ₃ set in the third region 13. In the light of the light intensity distribution (Gaussian distribution) of the incident light Lin shown in FIG. 10, the relative light intensity in the first region 11 is the highest, the relative light intensity in the third region 13 is the lowest, and the relative light intensity in the second region 12 is medium.

Meanwhile, the intensity of the Raman scattered light in each region is inversely proportional to the fourth power of the wavelength of the incident light Lin. Therefore, the shorter the wavelength of the incident light Lin, the higher the intensity of the Raman scattered light. Then, it can be said that it is preferable for the third region 13 to be disposed at the outer side where the light intensity is the smallest since the third region 13 is set to the third excitation wavelength λ₃ which is the shortest wavelength, it is preferable for the second region 12 to be disposed in an intermediate portion where the light intensity is medium since the second region 12 is set to the second excitation wavelength λ₂ which is the second shortest wavelength, and it is preferable for the first region 11 to be set to a central portion where the light intensity is the highest since the first region 11 is set to the first excitation wavelength Mi which is the longest wavelength. Accordingly, as described above, the intensities of the Raman scattered light in the respective regions can be made equal to each other, or the difference therebetween can be reduced. As a result, it is possible to realize the electric field enhancement device 100 easy to use.

Since the intensities of the Raman scattered light in the respective regions can be adjusted by the widths r1, r2, and r3 of the respective regions, the intensities of the Raman scattered light in the respective regions can be made equal to each other or different from each other as needed.

Note that in such a fourth modified example as described above, substantially the same advantages as those of the embodiment described above can be obtained.

### 3.5. Fifth Modified Example

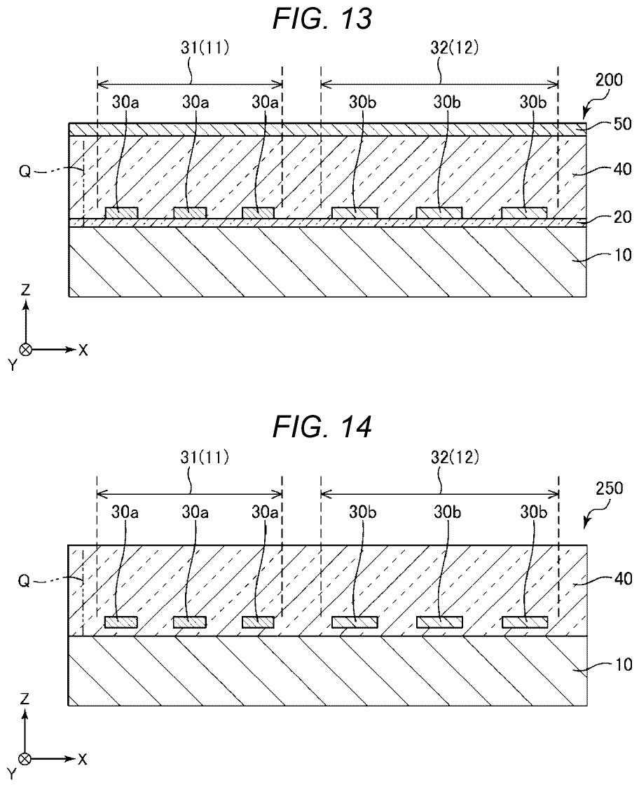

FIG. 13 is a cross-sectional view schematically illustrating an electric field enhancement device 200 according to a fifth modified example of the embodiment.

The fifth modified example will hereinafter be described focusing attention on differences from the embodiment described above, and the description of substantially the same matters will be omitted. Note that in FIG. 13, substantially the same configurations as those in the embodiment described above are provided with the same reference symbols.

The electric field enhancement device 200 shown in FIG. 13 is substantially the same as the electric field enhancement device 100 except that a molecular trapping layer 50 is provided.

The molecular trapping layer 50 is disposed on the transparent layer 40 so as to be in contact with the transparent layer 40. The molecular trapping layer 50 is an organic molecular film, and is, for example, a self-assembled monolayer (SAM).

The thickness of the molecular trapping layer 50 is not particularly limited, but is preferably no less than 0.1 nm and no more than 1 nm, and more preferably no more than 0.4 nm.

The thickness of the molecular trapping layer 50 is measured from an observation image obtained by observing a cross-section of the molecular trapping layer 50 with an electron microscope. In the observation image, the length in the Z-axis direction of the molecular trapping layer 50 is measured at 10 or more points randomly extracted, and an average value thereof is defined as the “thickness”.

The molecular trapping layer 50 has a function of trapping the target substance. The molecular trapping layer 50 is appropriately selected depending on the type of the target substance, and examples thereof include an alkanethiol film and a silane coupling agent. The molecular trapping layer 50 is formed by, for example, a dipping method, a vacuum deposition method, a molecular vapor deposition (MVD) method, or a CVD method.

In the electric field enhancement device 200, since the molecular trapping layer 50 is disposed on the transparent layer 40, deposition unevenness of the molecular trapping layer 50 can be alleviated. For example, when the transparent layer is not provided and the molecular trapping layer is directly deposited on the microstructures and the substrate, the physical and chemical states are different between the surfaces of the microstructures and the surface of the substrate, and thus the deposition unevenness of the molecular trapping layer may occur in some cases.

In addition, in the electric field enhancement device 200, as described above, since the target substance is not required to be located in the vicinity of the microstructure 30, the selectivity of the molecular chain length in the molecular trapping layer 50 increases. Note that although not illustrated, a primer layer for improving adhesion between the transparent layer 40 and the molecular trapping layer 50 may be disposed therebetween.

Note that in such a fifth modified example as described above, substantially the same advantages as those of the embodiment described above can be obtained.

### 3.6. Sixth Modified Example

FIG. 14 is a cross-sectional view schematically illustrating an electric field enhancement device 250 according to a sixth modified example of the embodiment.

The sixth modified example will hereinafter be described focusing attention on differences from the embodiment described above, and the description of substantially the same matters will be omitted. Note that in FIG. 14, substantially the same configurations as those in the embodiment described above are provided with the same reference symbols.

The electric field enhancement device 250 shown in FIG. 14 is substantially the same as the electric field enhancement device 100 except that the transparent layer 40 is extended instead of the dielectric layer 20 shown in FIG. 1. That is, the transparent layer 40 shown in FIG. 14 is also extended to the region where the dielectric layer 20 shown in FIG. 1 extends. Thus, there is provided a state in which the microstructures 30 are surrounded by the transparent layer 40 in the cross-section shown in FIG. 14.

Note that in such a sixth modified example as described above, substantially the same advantages as those of the embodiment described above can be obtained.

### 4. Raman Spectroscopic Apparatus

Then, a Raman spectroscopic apparatus according to the embodiment will be described.

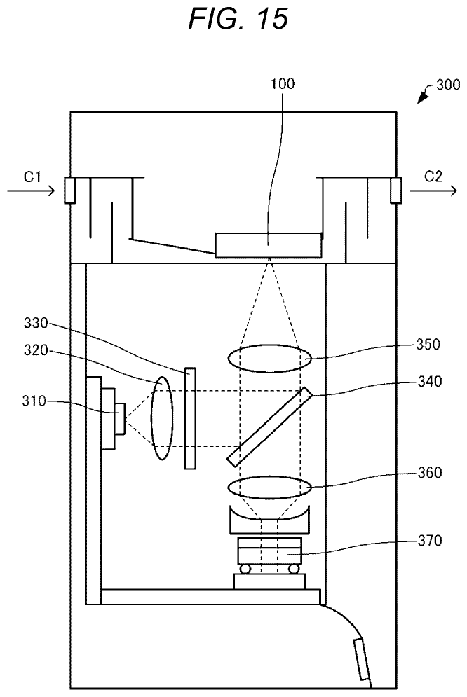

FIG. 15 is a diagram schematically showing a Raman spectroscopic apparatus 300 according to the embodiment.

### 4.1. Configuration

The Raman spectroscopic apparatus 300 shown in FIG. 15 includes the electric field enhancement device 100, a light source 310, a collimator lens 320, a polarization control element 330, a dichroic mirror 340, an objective lens 350, a condenser lens 360, and a detector 370. Note that for the sake of convenience of illustration, the electric field enhancement device 100 is simplified in FIG. 15.

The target substance is carried into the Raman spectroscopic apparatus 300 from a C1 direction and is then carried out in a C2 direction. For example, by driving a fan (not shown), the target substance is introduced from the carry-in port into a substance transport unit and is then discharged from a discharge port to the outside of the substance transport unit.

The light source 310 irradiates the electric field enhancement device 100 with the light. The light emitted from the light source 310 has a wavelength that induces resonance such as SLR and QGM in the electric field enhancement device 100. Examples of the light source 310 include a laser and a light emitting diode (LED). Examples of the laser include a vertical cavity surface emitting laser (VCSEL) and a photonic crystal surface emitting laser (PCSEL).

The light emitted from the light source 310 is, for example, collimated by the collimator lens 320, transmitted through the polarization control element 330, and guided toward the electric field enhancement device 100 by the dichroic mirror 340. The light traveling toward the electric field enhancement device 100 is condensed by the objective lens 350 and is incident on the electric field enhancement device 100. On this occasion, the target substance is in contact with the transparent layer 40 of the electric field enhancement device 100.

When the light is incident on the electric field enhancement device 100, the enhanced electric field E is generated by the plurality of microstructures 30. When the target substance is located in the enhanced electric field E, the SERS light is generated therefrom. The SERS light is transmitted through the objective lens 350, then transmitted through the dichroic mirror 340 to be guided toward the detector 370. The SERS light traveling toward the detector 370 is condensed by the condenser lens 360 and then enters the detector 370.

The detector 370 detects the SERS light emitted from the electric field enhancement device 100. The detector 370 is, for example, a diffraction grating spectrometer. Then, in the Raman spectroscopic apparatus 300, the detector 370 performs spectral decomposition on the SERS light to obtain spectral information. Note that the detector 370 may be a Fabry-Perot etalon spectrometer.

### 4.2. Principle

FIG. 16 is a diagram illustrating the principle of the Raman scattering spectroscopy.

In FIG. 16, the target substance X is irradiated with the incident light Lin having a wavelength Ain. Then, scattered light is emitted from the target substance X. The scattered light includes, besides the Rayleigh scattered light Ray having the same wavelength λ1 as the wavelength λin of the incident light Lin, the Raman scattered light Ram having a wavelength λ2 different from the wavelength λ1. An energy difference between the Raman scattered light Ram and the incident light Lin corresponds to the energy of an oscillation level, a rotation level, and an electron level of the target substance X. Since the target substance X has specific vibration energy according to the structure of the target substance X, the target substance X can be identified from the Raman scattered light Ram by using the incident light Lin having the wavelength λin.

FIG. 17 is a schematic diagram illustrating an example of a Raman spectrum acquired by the Raman scattering spectroscopy. In FIG. 17, the horizontal axis represents a Raman shift. The Raman shift is a difference between the wave number (frequency) of the Raman scattered light Ram and the wave number of the incident light Lin, and has a value specific to the molecular bonding state of the target substance X.

When comparing the scattered light intensity K1 of the Raman scattered light Ram and the scattered light intensity K2 of the Rayleigh scattered light Ray illustrated in FIG. 17 with each other, it is understood that the scattered light intensity K1 of the Raman scattered light Ram is weaker. As described above, the Raman scattering spectroscopy is excellent in ability to identify the target substance X, but has a problem that the sensitivity to detect the target substance X is low. Therefore, in the Raman spectroscopic apparatus 300, the SERS is used to achieve high sensitivity.

### 5. Advantages Provided by Embodiment

The electric field enhancement device according to the embodiment includes the substrate 10, the plurality of microstructures 30a, 30b, and the transparent layer 40. The microstructures 30a, 30b are disposed on the substrate 10 and have electrical conductivity. The transparent layer 40 covers the plurality of microstructures 30a, 30b and the substrate 10. Further, the electric field enhancement device according to the embodiment described above includes the first array 31 and the second array 32. The first array 31 is disposed in the first region 11 of the substrate 10 and is formed of the microstructures 30a arranged periodically. The second array 32 is disposed in the second region 12 different from the first region 11 of the substrate 10, and is formed of the microstructures 30b arranged periodically. Further, the first array 31 and the second array 32 are different from each other in at least one of the diameters of the microstructures 30a, 30b, the thicknesses of the microstructures 30a, 30b, and the pitch between the adjacent microstructures 30a, 30b.

According to such a configuration, the detection signal caused by the target substance can be enhanced without locating the target substance in the vicinity of the microstructures 30a, 30b. As a result, the electric field enhancement device capable of improving the detection sensitivity can be obtained. In addition, since it is not necessary to locate the target substance between the adjacent microstructures 30a, 30b, samples in various sizes such as viruses and bacteria can freely be selected as the target substance. Further, since the first array 31 and the second array 32 can generate the plasmon resonance by the incident light Lin having wavelengths different from each other, it is possible to realize the electric field enhancement device capable of coping with a plurality of wavelengths and high in convenience.

In the electric field enhancement device according to the embodiment, the first region 11 and the second region 12 may be disposed side by side via the boundary BL along the plane of the substrate 10.

According to such a configuration, it is possible to provide two regions different in array factor together with each other in one electric field enhancement device. Further, since it is possible to form a plurality of regions with relative ease, it is possible to realize the electric field enhancement device excellent in manufacturing easiness.

In the electric field enhancement device according to the embodiment described above, the area of the first region 11 and the area of the second region 12 may be different from each other.

According to such a configuration, since the area ratio can be set in accordance with the wavelength (first excitation wavelength) of the incident light Lin when the first array 31 generates the plasmon resonance and the wavelength 1 (second excitation wavelength) of the incident light Lin when the second array 32 generates the plasmon resonance, it is possible to approximate, for example, the intensity of the Raman scattered light generated by the incident light Lin having the first excitation wavelength λ₁ and the intensity of the Raman scattered light generated by the incident light Lin having the second excitation wavelength λ₂ to each other. Accordingly, it is possible to realize the electric field enhancement device in which the difference in the intensity of the Raman scattered light between the regions is small and which is easy to use.

In the electric field enhancement device according to the embodiment described above, the first region 11 and the second region 12 may be arranged concentrically.

According to such a configuration, it is possible to realize the electric field enhancement device capable of coping with the plurality of wavelengths of the incident light Lin and optimizing the ratio of the intensity of the Raman scattered light between the regions.

In the electric field enhancement device according to the embodiment, the second region 12 may be disposed at the outer side of the first region 11, and the area of the second region 12 may be larger than the area of the first region 11.

According to such a configuration, when the in-plane distribution of the light intensity of the incident light Lin is supposedly constant, the intensity of the Raman scattered light generated by the incident light Lin having the second excitation wavelength λ₂ can be selectively made higher. Further, when the in-plane distribution of the light intensity of the incident light Lin is, for example, a Gaussian distribution, the integrated values of the light intensity of the incident light Lin in the respective regions can be made equal to each other or the difference therebetween can be reduced.

In the electric field enhancement device according to the embodiment described above, when defining a wavelength at which the plasmon resonance is generated in the first array 31 as the first excitation wavelength λ₁ and a wavelength at which plasmon resonance is generated in the second array 32 as the second excitation wavelength λ₂, the second excitation wavelength λ₂ may be shorter than the first excitation wavelength λ₁.

According to such a configuration, the intensities of the Raman scattered light in the respective regions can be made equal to each other, or the difference between the intensities can be reduced. As a result, the electric field enhancement device easy to use can be realized.

In the electric field enhancement device according to the embodiment described above, the enhanced electric field E generated by the plurality of microstructures 30a, 30b may be maximized at a position above the microstructures 30a, 30b (at the opposite side of the microstructures 30a, 30b to the substrate 10) and separated from the plurality of microstructures 30a, 30b in the normal direction to the substrate 10.

According to such a configuration, the detection signal caused by the target substance disposed at the opposite side of the plurality of microstructures 30a, 30b to the substrate 10 (on the upper surface 42) can further be enhanced.

In the electric field enhancement device according to the embodiment described above, the enhanced electric field E may reach a position separated from the transparent layer 40 in the normal direction to the substrate 10.

According a configuration, the to such probability that the enhanced electric field E acts on the target substance disposed on the upper surface 42 increases. Therefore, the detection signal caused by the target substance can particularly be enhanced.

In the electric field enhancement device according to the embodiment described above, the material of the microstructures 30a, 30b is preferably metal.

According to such a configuration, the enhanced electric field E can further be strengthened.

The Raman spectroscopic apparatus according to the embodiment described above includes the electric field enhancement device according to the embodiment described above, the light source 310, and the detector 370. The light source 310 irradiates the electric field enhancement device with the light. The detector 370 detects the light from the electric field enhancement device.

According to such a configuration, it is possible to obtain the Raman spectroscopic apparatus 300 that is capable of improving the detection sensitivity, and coping with a plurality of wavelengths, and is thus high in convenience.

Although the electric field enhancement device and the Raman spectroscopic apparatus according to the present disclosure have been described based on the preferred embodiment illustrated in the drawings, the present disclosure is not limited to the embodiment and the modified examples. For example, the configuration of each unit in the embodiment and the modified examples described above may be replaced with any configuration having substantially the same function, or may be added with any other configuration. Further, what is obtained by combining two or more of the embodiments and the modified examples described above may be adopted.

### PRACTICAL EXAMPLES

Then, specific examples of the present disclosure will be described.

### 6. Experimental Examples

### 6.1. Practical Example 1

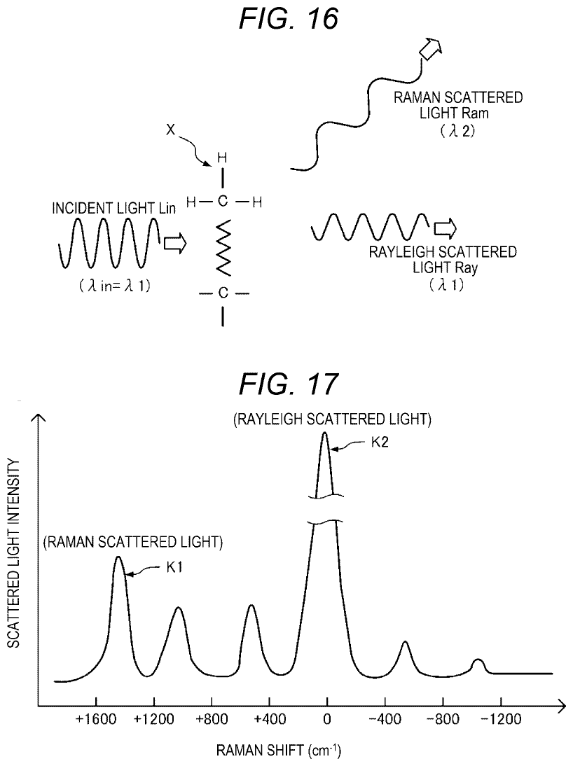

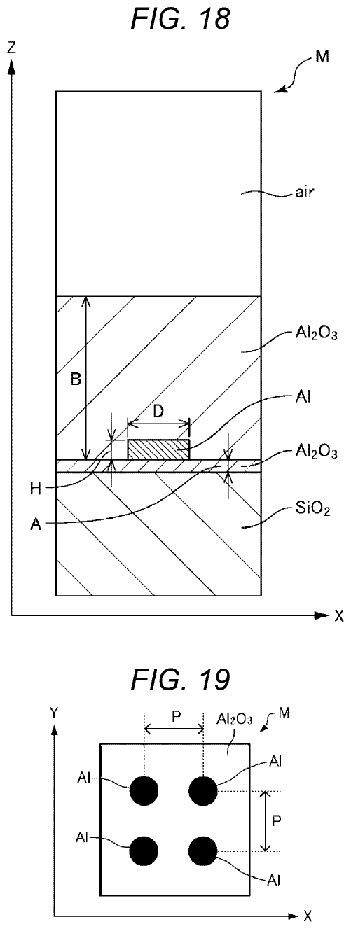

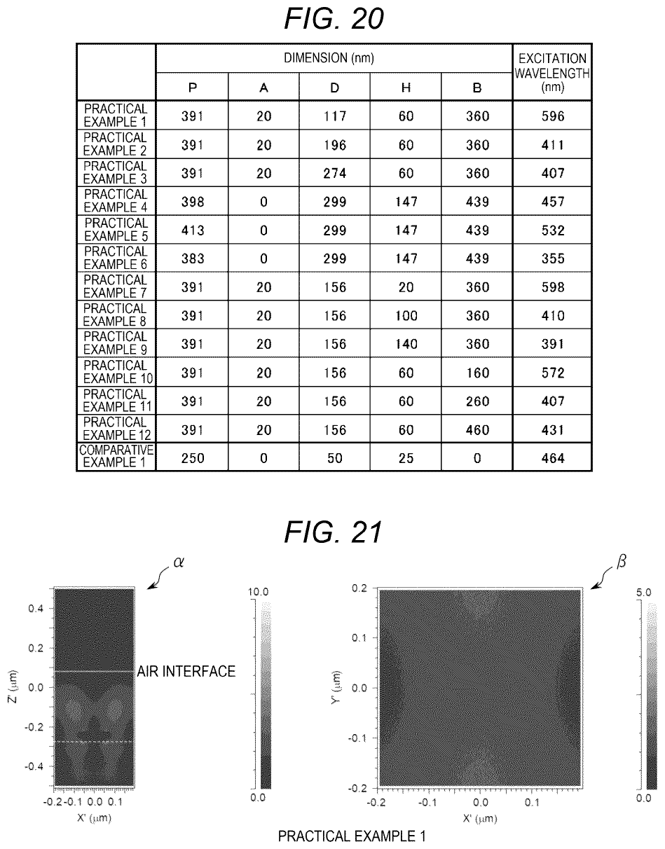

FIG. 18 is an X-Z cross-sectional view schematically illustrating a repeating unit of the model M used in a simulation. FIG. 19 is an X-Y cross-sectional view schematically illustrating the model M used in the simulation. FIG. 20 is a table showing a comparison of principal parameters in Practical Examples 1 to 12 and Comparative Example 1.

In the model M of Practical Example 1, as shown in FIG. 18, the material of the substrate was quartz glass (SiO₂), and the material of the dielectric layer and the material of the transparent layer were each Al₂O₃.

In addition, the thickness B of the transparent layer was 360 nm, the material of the microstructure was Al, the diameter D of the microstructure was 117 nm, the thickness H of the microstructure was 60 nm, and the thickness A of the dielectric layer was 20 nm. In addition, in the model M, as illustrated in FIG. 19, the array of the microstructures was in a square lattice shape, the shape of the microstructure was a cylinder, and the pitch P of the microstructures was 391 nm. Further, an air layer “air” was formed above the transparent layer.

Then, light was incident from the substrate side of the model M shown in FIG. 18, and the intensity distribution of the enhanced electric field was calculated. In addition, the wavelength of the incident light when the enhanced electric field was maximized was set as the excitation wavelength. The excitation wavelength in the model M of Practical Example 1 was 596 nm.

### 6.2. Practical Examples 2 to 12

In Practical Examples 2 to 12, the intensity distribution of the enhanced electric field was calculated in substantially the same manner as in Practical Example 1 except that the parameters were changed as shown in FIG. 20 in the model M described above. Further, the excitation wavelength in the model M of each Practical Example is shown in FIG. 20.

### 6.3. Comparative Example 1

In Comparative Example 1, the intensity distribution of the enhanced electric field was calculated in substantially the same manner as in Practical Example 1 except that the thickness B of the transparent layer was zero, that is, the transparent layer was not provided, the material of the microstructures was Ag, the diameter D of the microstructure was 50 nm, the thickness H of the microstructure was 25 nm, the pitch P of the microstructures was 250 nm, and the wavelength of the incident light was 464 nm.

### 7. Results in Experimental Examples

In each of the models of Practical Examples 1 to 12 and Comparative Example 1 described above, the simulation for estimating the distribution of the enhanced electric field was performed. A finite difference time domain (FDTD) method was used for the simulation. As simulation software, RSoft manufactured by Synopsys, Inc. was used.

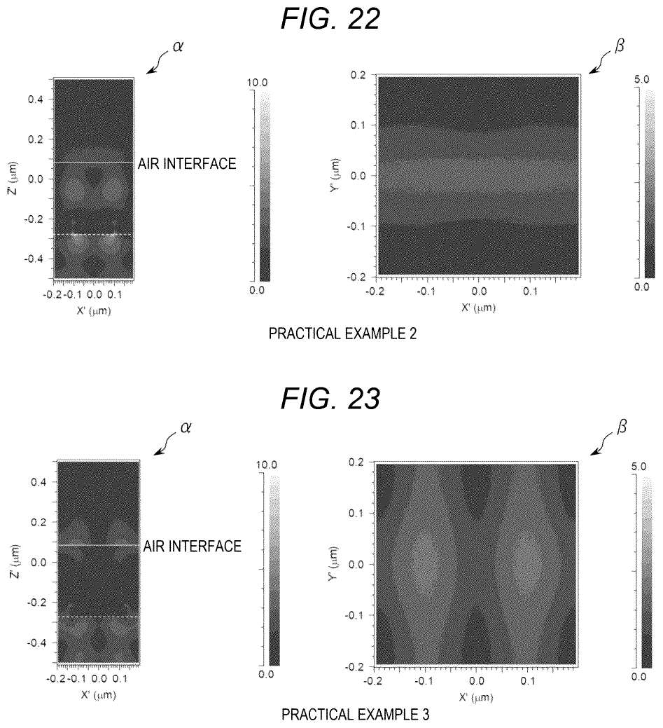

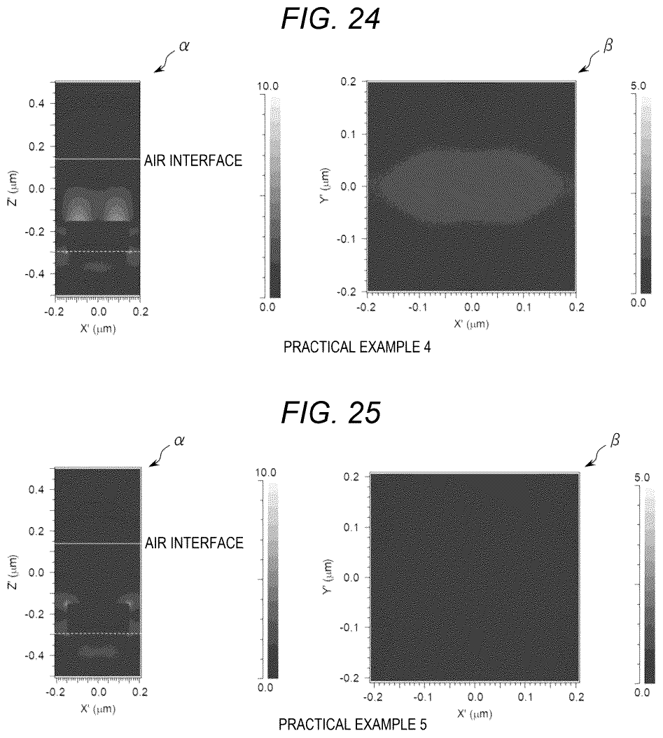

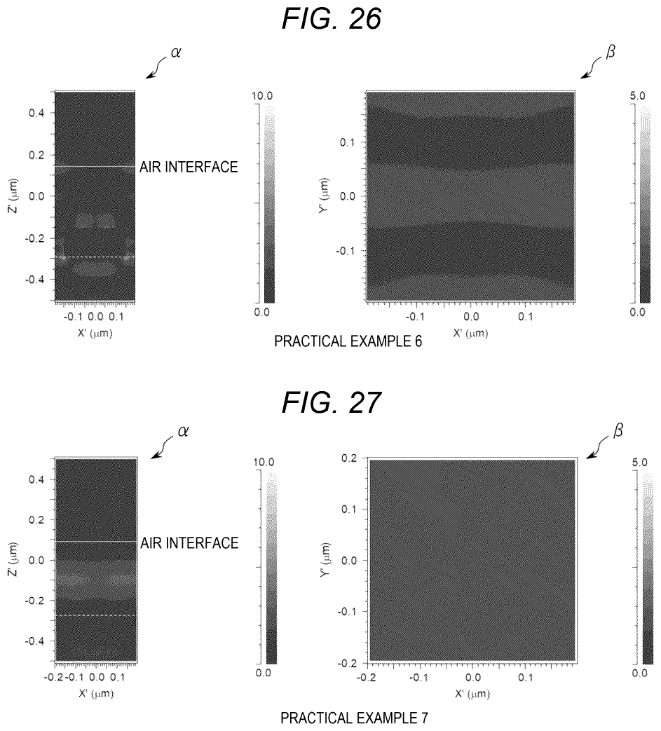

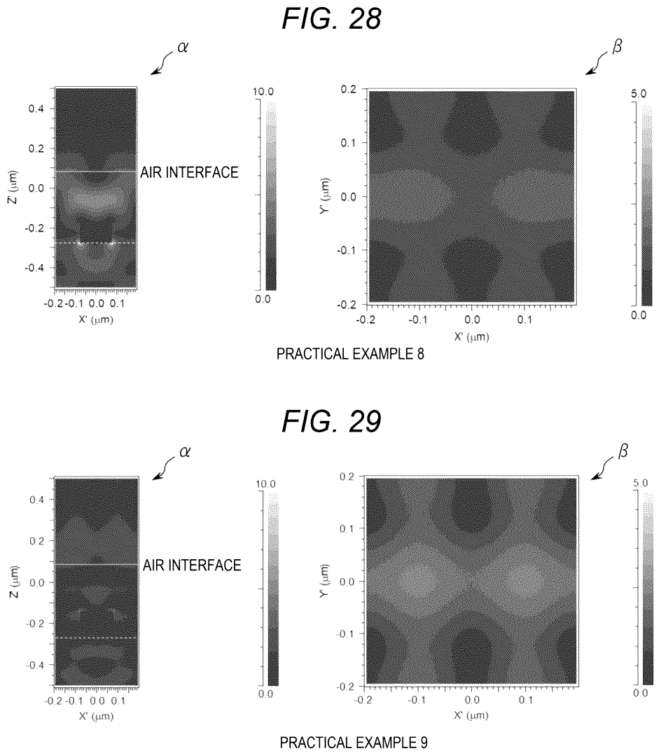

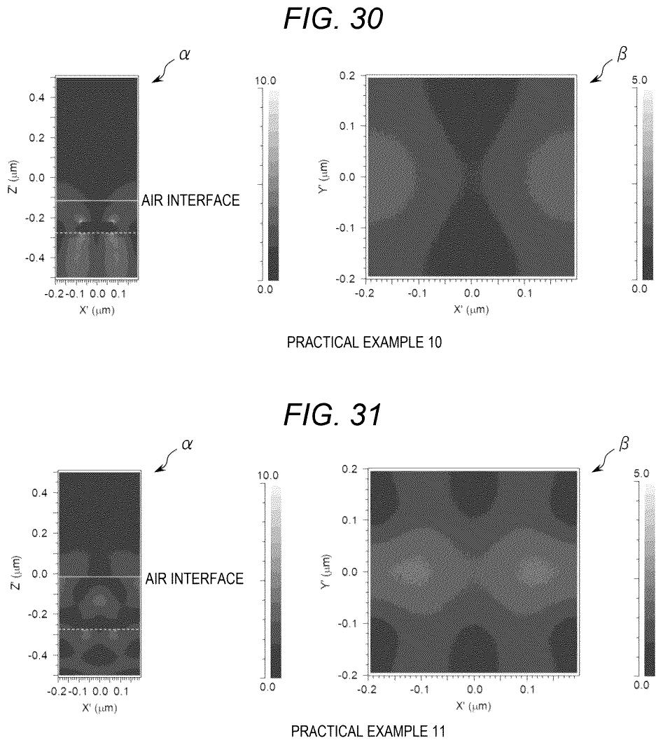

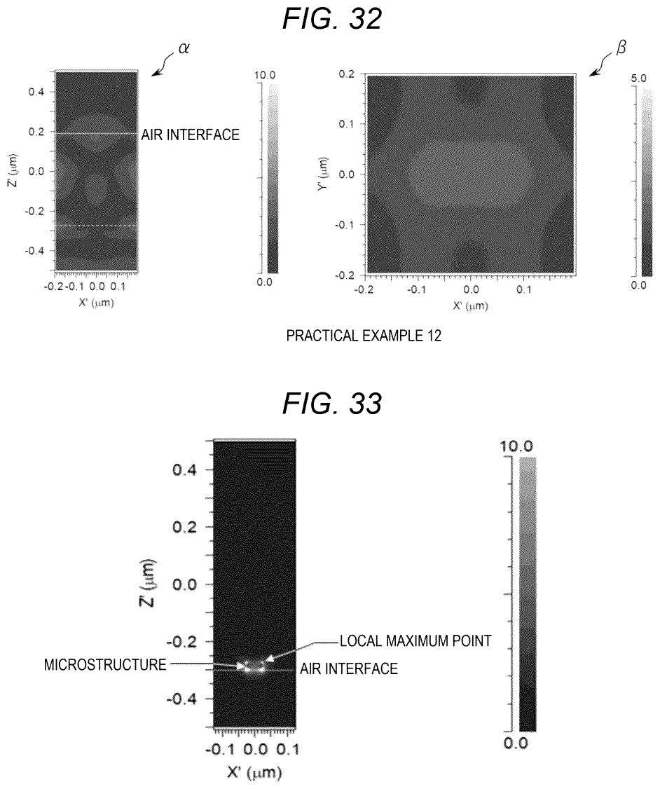

FIGS. 21 to 33 show simulation results in Practical Examples 1 to 12 and Comparative Example 1. FIGS. 21 to 32 each show a normalized distribution x of the enhanced electric field in the X-Z cross-section, and a normalized distribution β of the enhanced electric field in the X-Y cross-section that is separated upward from the air interface by 100 nm and has the origin at a position corresponding to the center of the microstructure.

The shading in FIGS. 21 to 33 represents the intensity of the enhanced electric field. In the distribution α, when the X component of the enhanced electric field is represented by Ex and the Z component of the enhanced electric field is represented by Ez, a square root of (Ex²+Ez²), that is, √(Ex²+Ez²) is reflected in the shading. In the distribution β, when the X component of the enhanced electric field is represented by Ex and the Y component of the enhanced electric field is represented by Ey, a square root of (Ex²+Ey²), that is, √(Ex²+Ey²) is reflected in the shading.

In FIGS. 21 to 32, the “AIR INTERFACE” represents an interface between the transparent layer and the air layer. In FIG. 33, the “AIR INTERFACE” represents the interface between the substrate and the air layer.

In each of the distributions α in FIGS. 21 to 32, it was confirmed that a light color was enhanced at a position where the microstructure was separated upward, and the light color spread above the air interface (at the air layer side). In addition, in the distributions β in FIGS. 21 to 32, a predetermined pattern was confirmed at a position separated upward from the air interface by 100 nm. From these results, in FIGS. 21 to 32, it was confirmed that the enhanced electric field was maximum at the position separated upward from the microstructure, and the enhanced electric field reached above the air interface (at the air layer side).

On the other hand, in FIG. 33, no enhanced electric field was observed at a position away from the microstructure.

In addition, in the light of the results in FIGS. 21 to 32, it was also confirmed that the excitation wavelength could be changed by changing the array factor (at least one of the diameter D of the microstructure, the thickness H of the microstructure, and the pitch P between the adjacent microstructures) out of the parameters of the model M.

For example, in Practical Examples 1 to 3, the diameters D of the microstructures were made different from each other, and thus the excitation wavelength could be changed.

In addition, in Practical Examples 4 to 6, the pitches P between the adjacent microstructures were made different from each other, and thus the excitation wavelength could be changed.

Further, in Practical Examples 7 to 9, the thicknesses H of the microstructures were made different from each other, and thus the excitation wavelength could be changed.

Further, in Practical Examples 10 to 12, the thicknesses B of the transparent layers were made different from each other, and thus the excitation wavelength could be changed.

In the light of the above results, it was confirmed that the excitation wavelength could be changed by making the first array, the second array, and the third array described above different in array factors from each other.

What is claimed is:

1. An electric field enhancement device, comprising:
a substrate;
a plurality of microstructures provided to the substrate and having electrical conductivity;
a transparent layer configured to cover the plurality of microstructures and the substrate;
a first array disposed in a first region of the substrate and including the microstructures periodically arranged; and
a second array disposed in a second region of the substrate different from the first region of the substrate and including the microstructures periodically arranged, wherein
the first array and the second array are different from each other in at least one of a diameter of the microstructures, a thickness of the microstructures, and a pitch between the microstructures adjacent to each other.

2. The electric field enhancement device according to claim 1, wherein
the first region and the second region are disposed side by side via a boundary along a plane of the substrate.

3. The electric field enhancement device according to claim 2, wherein
an area of the first region and an area of the second region are different from each other.

4. The electric field enhancement device according to claim 1, wherein
the first region and the second region are concentrically arranged.

5. The electric field enhancement device according to claim 4, wherein
the second region is disposed at an outer side of the first region, and
an area of the second region is larger than an area of the first region.

6. The electric field enhancement device according to claim 5, wherein
when defining a wavelength at which plasmon resonance is generated in the first array as a first excitation wavelength and a wavelength at which plasmon resonance is generated in the second array as a second excitation wavelength,
the second excitation wavelength is shorter than the first excitation wavelength.

7. The electric field enhancement device according to claim 1, wherein
an enhanced electric field generated by the plurality of microstructures is maximized at a position which is at an opposite side of the microstructures to the substrate in a normal direction to the substrate and is separated from the plurality of microstructures.

8. The electric field enhancement device according to claim 7, wherein
the enhanced electric field reaches a position separated from the transparent layer in the normal direction.

9. The electric field enhancement device according to claim 1, wherein
the microstructure is composed of metal.

10. A Raman spectroscopic apparatus, comprising:
the electric field enhancement device according to claim 1;
a light source configured to irradiate the electric field enhancement device with light; and
a detector configured to detect light from the electric field enhancement device.

11. A Raman spectroscopic apparatus, comprising:
the electric field enhancement device according to claim 2;
a light source configured to irradiate the electric field enhancement device with light; and
a detector configured to detect light from the electric field enhancement device.

12. A Raman spectroscopic apparatus comprising:
the electric field enhancement device according to claim 3;
a light source configured to irradiate the electric field enhancement device with light; and
a detector configured to detect light from the electric field enhancement device.

13. A Raman spectroscopic apparatus, comprising:
the electric field enhancement device according to claim 4;
a light source configured to irradiate the electric field enhancement device with light; and
a detector configured to detect from the light electric field enhancement device.

14. A Raman spectroscopic apparatus, comprising:
the electric field enhancement device according to claim 5;
a light source configured to irradiate the electric field enhancement device with light; and
a detector configured to detect light from the electric field enhancement device.

15. A Raman spectroscopic apparatus, comprising:
the electric field enhancement device according to claim 6;
a light source configured to irradiate the electric field enhancement device with light; and
a detector configured to detect light from the electric field enhancement device.
